(19) United States
(12) Patent Application Publication
(10) Pub. No.: US 2013/0007764 A1
(43) Pub. Date: Jan. 3, 2013

(54) ASSIGNING WORK TO A PROCESSING ENTITY ACCORDING TO NON-LINEAR REPRESENTATIONS OF LOADINGS

(76) Inventors: Eric C. Corum, Georgetown, TX (US); Wesley R. Erhart, McKinney, TX (US); Channarong Tontiruttananon, Richardson, TX (US)

(21) Appl. No.: 13/615,420

(22) Filed: Sep. 13, 2012

Related U.S. Application Data
(63) Continuation of application No. 12/006,132, filed on Dec. 31, 2007.

(51) Int. Cl. G06F 9/46

(52) U.S. Cl. 718/105

(57) ABSTRACT

To perform load balancing across plural processing entities, load level indications associated with plural processing entities are received. The load level indications are representations based on applying a concave function on loadings of the plural processing entities. A processing entity is selected from among the plural processing entities to assign work according to the load level indications.

### TECHNICAL FIELD

The invention relates generally to selecting a processing entity from among plural processing entities to assign work according to load level indications that are non-linear representations of loadings of the plural processing entities.

### BACKGROUND

In a network system, various processing entities may be present that are capable of performing work to be assigned by one or more controllers. A “processing entity” refers to any physical or logical device in the network system that is capable of performing work associated with one or more particular applications.

Load balancing algorithms may be used to balance workload among multiple processing entities. Various types of conventional load balancing algorithms exist. One example type of a conventional load balancing algorithm is a round robin algorithm in which processing entities are selected in sequential order for work assignment, with the selection re-starting from the beginning once an end of a group of processing entities has been reached. Round robin load balancing can include either simple round robin load balancing or weighted round robin load balancing. In weighted round robin load balancing, each processing entity is assigned a weight, with some processing entities assigned larger weights than others to increase the chances that such processing entities will be assigned work. Simple round robin load balancing is just a special case of weighted round robin load balancing, where the weight of each processing entity is assigned the value one.

Another type of conventional load balancing algorithm is a weighted load balancing algorithm in which new work is assigned to the least loaded processing entity.

An issue associated with conventional load balancing algorithms is that they are unable to efficiently handle sudden bursts of workload, such as bursts associated with re-assigning work to other processing entities when one or more processing entities become unavailable (e.g., due to failure, being reset, etc.). The unavailability of even just one processing entity may lead to an increased burst of work that was previously handled by the processing entity. The sudden burst of work that has to be re-assigned can lead to large variations in workload at the processing entities and/or increased processing delay by some processing entities when conventional load balancing algorithms are used. Also, with conventional load balancing algorithms, bursts of work resulting from processing entity(ies) becoming unavailable can stress the overall system and increase the length of time for the overall system to reach a stable state.

### SUMMARY

In general, according to an embodiment, a method of performing load balancing across plural processing entities includes receiving load level indications from the plural processing entities, where the load level indications are representations based on applying a concave function on loadings of the plural processing entities. A processing entity is selected from among the plural processing entities to assign work according to the load level indications.

Other or alternative features will become apparent from the following description, from the drawings, and from the claims.

### BRIEF DESCRIPTION OF THE DRAWINGS

FIG. 1 illustrates loadings of a processing entity on a companding scale, according to an embodiment.

FIG. 2 is a block diagram of an example network system of controllers and processing entities in which a load balancing algorithm according to an embodiment can be implemented.

FIG. 3 is a block diagram of a mobile communications network that includes a node having plural controllers and processing entities on which a load balancing algorithm according to an embodiment can be implemented.

FIG. 4 is a flow diagram of a scheduling procedure according to an embodiment.

FIG. 5 is a graph illustrating hysteresis used for increasing or decreasing load levels of a processing entity, according to an embodiment.

### DETAILED DESCRIPTION

In the following description, numerous details are set forth to provide an understanding of some embodiments. However, it will be understood by those skilled in the art that some embodiments may be practiced without these details and that numerous variations or modifications from the described embodiments may be possible.

In accordance with some embodiments, a network system includes an arrangement of controllers and processing entities, where the controllers are able to assign work to the processing entities. Assigning “work” to a processing entity refers to assigning a task (or set of tasks) to be performed by the processing entity, where each task can be any of the following: communication of data traffic (e.g., voice data, packet data, video data, etc); communication of control traffic (e.g., control messaging), or any other processing task.

At least some of the controllers are able to use a companding weighted load balancing algorithm according to some embodiments to assign work to the processing entities. The companding weighted load balancing algorithm uses weights associated with the processing entities to decide which processing entities are to be selected for work assignment. In some embodiments, the weights associated with the processing entities are in the form of load level indications (or “load levels”) that are logarithmic representations of loadings of the processing entities. A “loading” of a processing entity can refer to any of the following: a number of sessions being handled by the processing entity; an amount of total workload being handled by the processing entity; a percentage of total processing capacity of the processing entity that is consumed; the speed at which data is processed; and so forth. A load level that is a logarithmic representation of a loading of a processing entity is calculated by using a logarithmic formula that is applied to the current loading of the processing entity.

Alternatively, instead of being a logarithmic representation of a loading of a processing entity, a load level can be based on a concave function of the loading of the processing entity. A concave function is a function in which a straight line joining any two points on the graph of the function lies on or below the graph of the function. A logarithmic formula applied to a loading is an example of a concave function applied to the loading. A concave function, like a logarithmic function, is a non-linear function.

In the ensuing discussion, reference is made to logarithmic representations of loadings; however, techniques according to some embodiments are applicable to other types of representations based on concave functions.

In addition to using load levels that are logarithmic representations of loadings of processing entities, the load balancing algorithm according to some embodiments can also use a window flow control procedure to limit the number of service requests (for assigning work) that can be submitted by controllers to any processing entity. Also, processing entities that have the same load level form a target set of processing entities. The load balancing algorithm can then use a round robin or random selection algorithm to select a processing entity from the target set. The window flow control procedure and round robin/random selection algorithms are discussed further below.

Using logarithmic values for defining the load levels of a processing entity allows for load levels corresponding to lower loadings of the processing entity to be closer (in terms of values of the loadings) to each other than load levels corresponding to larger loadings of the processing entity. In other words, lower load levels are associated with narrower variations of loadings of the processing entity, whereas higher load levels are associated with wider variations of loadings of the processing entity. Note that the characteristic of narrower variations for lower load levels and wider variations for higher load levels is also true of representations based on concave functions. Generally, the weights (in the form of the load levels) assigned to a processing entity are non-linear, and more specifically, are based on concave functions (logarithmic functions in some embodiments).

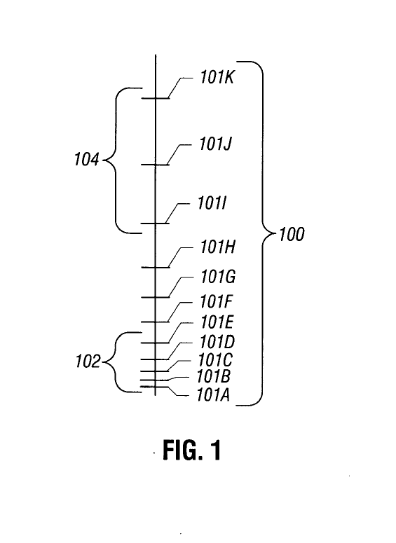

FIG. 1 depicts loadings of a processing entity on a companding scale 100, according to an example. Several discrete load levels (or weights) are depicted with horizontal lines 101 (101A-101K shown in FIG. 1). Each load level 101 is calculated by applying a logarithmic formula to the corresponding loading of the processing entity. The scale 100 represents values of loadings (lowest loading at the bottom of the scale 100 and highest loading at the top of the scale 100) of the processing entity. If loading is expressed as a number of sessions being handled by the processing entity, then the lowest loading refers to a lowest number of sessions, whereas the highest loading refers to a highest number of sessions.

In the lower part 102 of the scale 100, the loading levels 101 are closer together than in the upper part 104 of the scale 100. In other words, the range of loadings between two successive load levels 101 in the lower part 102 of the scale 100 is smaller than the range of loadings between two successive load levels 101 in the upper part 104 of the scale 100, as indicated by the difference in the distances between load levels 101 in the lower part 102 and in the upper part 104 of the scale 100.

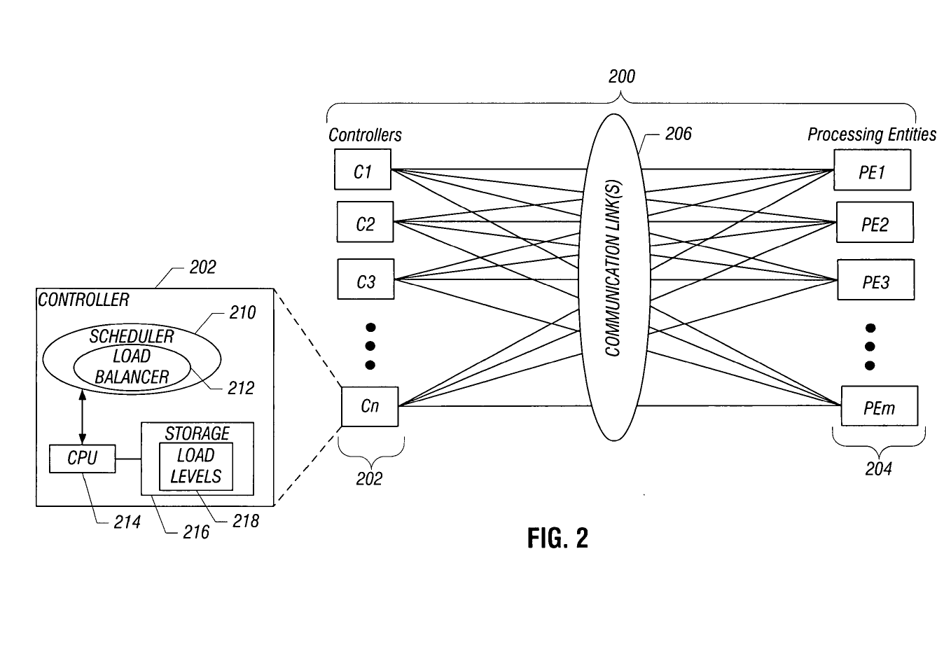

FIG. 2 shows an example network system 200 that has a number of controllers 202 (C1, C2, C3, . . . , Cn), and a number of processing entities 204 (PE1, PE2, PE3 . . . , P3m), where n and m are integers, with n≧1, and m≧2. The controllers 202 and processing entities 204 are interconnected by one or more communications links 206. Each controller 202 has a scheduler that is able to assign work to the processing entities 204. The schedulers 202 in the multiple controllers 202 can perform scheduling concurrently to assign work to the processing entities. The network system 200 can include an arrangement of plural separate controller nodes (202) and plural separate processing entity nodes (204). Alternatively, the network system 200 can be a single node that has plural controllers and processing entities.

Details of an example controller 202 are depicted in FIG. 2, where the controller 202 includes a scheduler 210 that has a load balancer 212 according to an embodiment. The scheduler 210 and load balancer 212 can be software modules executable on one or more central processing units (CPUs) 214. The CPU(s) is (are) connected to a storage 216 that is able to store load levels 218 associated with corresponding processing entities 204.

The processing entities 204 may periodically or intermittently provide load information to the controllers 202. The communication of load information can occur frequently in some implementations. The load information that is provided to the controllers 202 by the processing entities 204 can be the logarithmic load levels (calculated by the corresponding individual processing entities 204 based on their respective loadings), or alternatively, the load information provided can be loadings of the corresponding processing entities (from which the controllers can calculate the logarithmic load levels).

The load balancer 212 in each of at least some of the controllers 202 is able to use a weighted load balancing algorithm in which weights (load levels) assigned to processing entities are based on a logarithmic scale. In some embodiments, such a load balancing algorithm is referred to as a companding weighted load balancing algorithm.

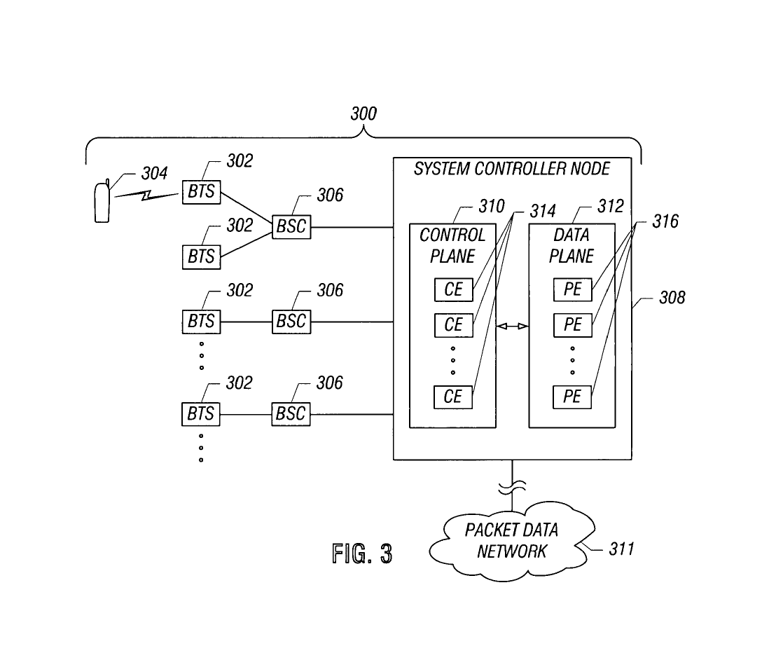

FIG. 3 illustrates a more specific example of a network system, which is a mobile communications network system 300. The mobile communications network system 300 includes base transceiver stations (BTS) 302 that are able to communicate wirelessly (e.g., over radio frequency or RF links) with corresponding mobile stations 304. The BTS 302 are connected to respective base station controllers 306 (also referred to as radio network controllers in some contexts). The base station controllers 306 are interconnected to a system controller node 308, which can be any one of the following: (1) a mobile switching center; (2) a packet data serving node (PDSN), such as according to a code division multiple access (CDMA) 2000 protocol; a serving GPRS (General Packet Radio Service) support node (SGSN) according to a UMTS (Universal Mobile Telecommunications System) or GSM (global system for mobile) protocol; and other types of system controller nodes. The system controller node 308 is coupled to a packet data network 311 (e.g., Internet, local area network, wide area network, etc.) through one or more routers (not shown).

In the example of FIG. 3, the system controller node 308 includes a control plane 310 and a data plane 312. The control plane 310 is used to communicate with base station controllers 306 for establishing, terminating, or otherwise managing communications sessions with mobile stations 304. The data plane 312 is used to communicate bearer traffic (e.g., voice traffic, packet data traffic, etc.) in the established communications sessions. The control plane 310 is logically or physically partitioned into plural control entities 314, and the data plane 312 is logically or physically partitioned into plural processing entities 316. The control entities 314 of the control plane 310 correspond to the controllers 202 of FIG. 2, while the processing entities 316 of the data plane 312 correspond to the processing entities 204 of FIG. 2. The control entities 314 in the control plane 310 are able to assign work to the processing entities 316 in the data plane 312.

Note that other nodes in the mobile communications network system can similarly include control planes and data planes partitioned into corresponding control entities and processing entities.

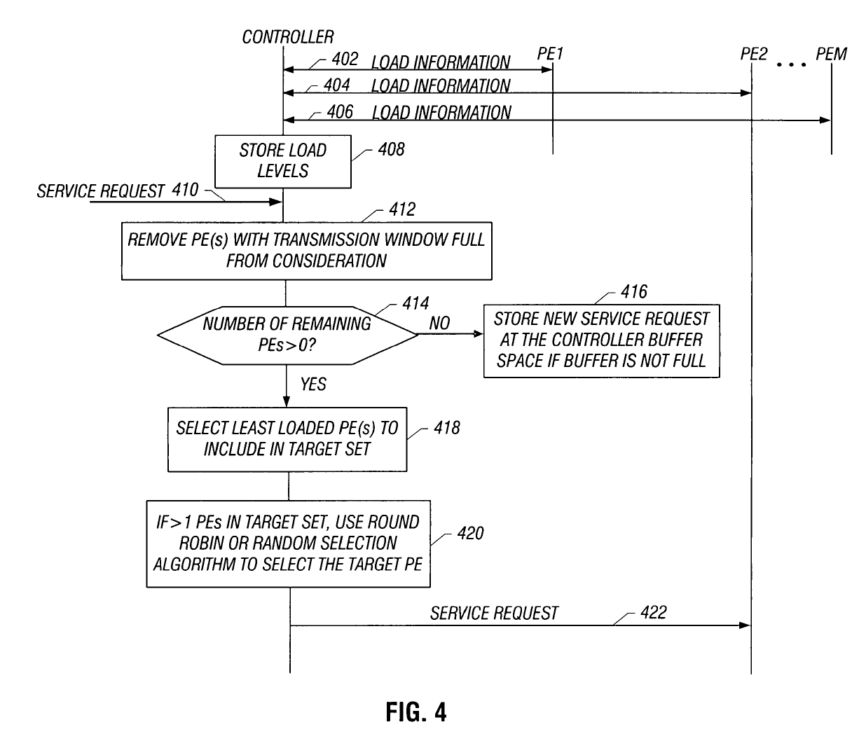

FIG. 4 shows a general flow diagram that illustrates a scheduling procedure that uses the companding weighted load balancing algorithm according to some embodiments. The various processing entities PE1, PE2, . . . PEm of the network system send (at 402, 404, 406) load information to a controller, which can be any of the controllers 202 or control entities 314 in FIGS. 2 and 3, respectively. The term “controller” or “control entity” is intended to refer to just software, or alternatively, to a combination of software and hardware. The load information communicated from the processing entities can be the logarithmic weights (load levels), or alternatively, the load information can be the current loadings of the processing entities (e.g., number of sessions being handled by the processing entities, load on CPU(s) of the processing entities, and so forth), which can then be converted by the controller to the logarithmic weights according to some embodiments.

The logarithmic load levels (either communicated by the processing entities or calculated by the controller) are stored (at 408) in the storage (216 in FIG. 2) of the controller. In response to a service request received (at 410), the controller determines whether a ‘transmission window” of any processing entity is full. In some embodiments, the controller uses a window flow control procedure to set a limit on the number of service requests (for assigning units of work) that can be sent to any particular processing entity. The window flow control procedure specifies a transmission window, which contains a number of service requests that have been submitted to and is currently pending at the corresponding processing entity. A service request is added to the transmission window, which becomes full when the maximum number of service requests has been reached. If the transmission window is not full, then the controller is able to send another service request to assign a unit of work to the corresponding processing entity. A “unit of work” refers to some amount of work that can be assigned to a processing entity.

Processing entity(ies) with full transmission windows are removed from consideration (at 412) in selecting a target set of one or more processing entities. Next, the controller determines (at 414) whether the number of remaining processing entities (with non-full transmission windows) is greater than zero. If not, which means that the transmission windows of all processing entities are full, the new service request received at 410 is stored (at 416) into a buffer of the controller if the buffer is not full. If the buffer is full, then the new service request is discarded by the controller.

On the other hand, if the number of remaining processing entities is greater than zero, as determined at 414, then the scheduler 210 (FIG. 2) selects (at 418) a target set of processing entities, where the target set includes one or more processing entities associated with respective load levels. In one embodiment, the target set of processing entities selected are the processing entities with the lowest load level. If the number of processing entities in the target set is greater than one (which means that there are multiple processing entities having equal load levels), then a round robin selection algorithm (or a random selection algorithm) is used (at 420) to select from among the processing entities in the target set. It is assumed that the processing entity selected is PE2. Note, however, that if the target set has just one processing entity, then the round robin selection algorithm or random selection algorithm does not have to be used. This single processing entity is the processing entity with the lowest load level.

A round robin selection algorithm selects processing entities in sequential order for work assignment, with the selection re-starting from the beginning once an end of the target set of processing entities has been reached. A random selection algorithm uses a pseudo-random number generator to generate a random number which is then used to select a processing entity from the target set.

Assuming that PE2 is the selected processing entity, the service request is sent (at 422) to PE2. The procedure of FIG. 4 is repeated for assigning additional units of work to the processing entities. Tasks 402, 404, and 406 are continually (repeatedly or intermittently) performed to update the load information of the processing entities PE1, PE2, . . . , PEm. Also, note that the procedure of FIG. 4 can be concurrently performed with multiple controllers that are able to concurrently assign work to the processing entities. In view of this, the window flow control procedure serves to limit the amount of work that can be assigned to any particular processing entity within a small time duration.

As noted above, the loading of a processing entity can be any one of the following: the number of sessions being handled by the processing entity; the amount of total workload handled by the processing entity; the percentage of total capacity of the processing entity consumed; the speed at which data is being processed by the processing entity; and so forth. In the ensuing discussion, it is assumed that processing entity loading is a number of sessions.

A load level V_{L}(Λ) according to one example embodiment is defined as follows:

$${V}_{L} ( 𝓁 ) = ⌈ ( {2}^{x} - 1 ) \cdot \frac{{log}_{2} ( 1 + ( {2}^{x} - 1 ) \cdot \frac{𝓁}{{𝓁}_{m ax}} )}{{log}_{2} ( {2}^{x} )} ⌉ , \qquad ( Eq . 1 )$$

where x represents the number of data bits that make up the load level V_{L} (Λ), Λ represents the current loading of the processing entity (which in one example is the number of sessions), and Λₘₐₓ represents the maximum supported loading of the processing entity (e.g., maximum number of sessions that can be handled by a processing entity at any one time).

Note that the load level V_{L}(Λ) is calculated by taking a logarithm (to base 2) of a value that is computed based on the loading Λ. More specifically, the logarithm (to base 2) is taken of the following value: the ratio of Λ to Λₘₐₓ multiplied by (2^{x}−1), plus the value 1. The base 2 logarithm of this value is taken as the numerator to be divided by the denominator log₂ (2^{x}) , which then is multiplied by (2^{x}−1) to produce a computed value. The computed value is then rounded up to the nearest integer greater than or equal to the computed value, according to Eq. 1, to produce V_{L}(Λ).

In other implementations, other equations can be used for calculating V_{L} (Λ) that is based on taking the logarithm of a value that includes current loading Λ. In Eq. 1, (2^{x}−1), log₂ (2^{x}), and Λₘₐₓ are constants, such that the only variable for calculating V_{L}(Λ) is the current loading Λ. More generally, Eq. 1 can be expressed as:

V_{L}(Λ)=c·log_{b}(f(Λ)), (Eq. 2)

where c is a constant, log_{b} represents a logarithm to base b (b≧2), and f(Λ) represents a function that is based at least in part on Λ. Eqs. 1 and 2 are example logarithmic formulas that can be applied to processing entity loadings to produce load levels (weights) according to some embodiments.

As noted above, when processing entities within a target set are at the same load level, a controller selects the processing entities using either a round robin selection algorithm or a random selection algorithm, which helps to distribute incoming work units across processing entities at the same load level.

In some cases, the average loading of a particular processing entity may be near a boundary of one of the logarithmic weights. There are two cases to examine: (1) the average loading of the processing entity just above the boundary; and (2) the average loading of the processing entity just below the boundary.

The case where the average loading of all processing entities in the network system is just below the boundary is fairly benign. In this case, a processing entity may momentarily be above the average loading value and can be removed as a candidate for selection for some temporary amount of time (until the loading of the processing entity drops below the boundary). The controller can then spread the workload among the processing entities that remain below the boundary.

However, the case where the average loading of all the processing entities of the network system is above the boundary poses more of a challenge. In this case, when a particular processing entity momentarily falls below the boundary, the controllers will all attempt to select that particular processing entity to receive new workload, excluding the majority of the processing entities that are above the boundary from selection. This can result in a “single target effect,” where workload is targeted to a single processing entity. To address this issue, load level hysteresis can be provided, where the threshold for dropping a processing entity to a lower level is different from the threshold for raising the processing entity to the next level.

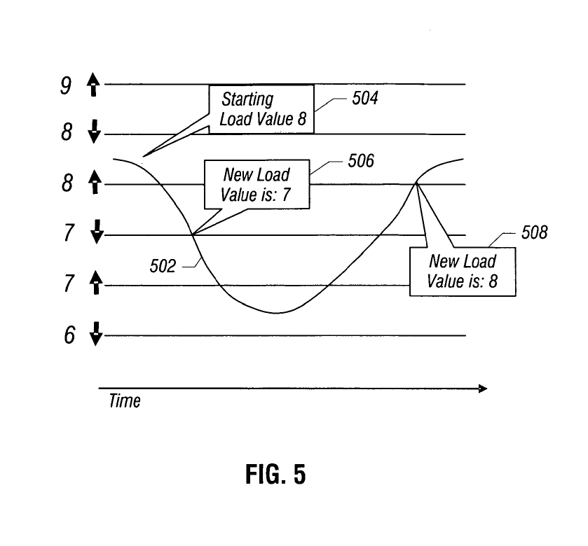

FIG. 5 shows an example of threshold hysteresis that can be provided. In this case, it is assumed that a processing entity starts with a loading (e.g., number of sessions) (represented by curve 502) that is above the “raise to 8” threshold but below the “drop to 8” threshold. As a result, the load level assigned to the processing entity is set at “8” (504 in FIG. 5). As time progresses, the loading on the processing entity drops until the “drop to 7” threshold is reached (506), in which case the load level of the processing entity is set to 7. The processing entity maintains this load level setting (7) until the loading increases to the “raise to 8” threshold (508), at which point the load level setting is changed back to 8.

In the example of FIG. 5, the first threshold (“raise threshold”) for raising a processing entity to a particular load level is less than the second threshold (“drop threshold”) for dropping the processing entity to the particular load level.

Instructions of software discussed above (e.g., scheduler 210 in FIG. 2) are executed on a processor (e.g., one or more CPUs 214). The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

1-20. (canceled)

21. A method of performing load balancing across plural processing entities, the method comprising:
receiving load level indications associated with processing entities, each load level indication being a representation based upon a non-linear function that is applied to a loading of an individual processing entity;
selecting a processing entity from among the processing entities to assign work to according to the load level indications; and
assigning work to the processing entity selected according to the load level indications.

22. The method of claim 21, wherein the non-linear function is a concave function.

23. The method of claim 21, wherein each of the load level indications is computed by applying a logarithmic formula to the corresponding loading of a corresponding one of the processing entities, the non-linear function being the logarithmic formula.

24. The method of claim 21, wherein lower load values have narrower variations in loading and higher load levels have wider variations in loadings.

25. The method of claim 21, wherein assigning the work uses a window flow control procedure in which a limit is set on a number of work units that can be assigned to the processing entity originally selected.

26. The method of claim 25, the method further comprising selecting a second processing entity according to the load level indications in response to detecting that the limit on the number of work units has been reached in assigning work to the processing entity originally selected.

27. The method of claim 26, the method further comprising receiving updated load level indications associated with the processing entities, wherein selecting the second processing entity is according to the updated load level indications.

28. The method of claim 21, the method further comprising determining that the load level indications of at least some of the processing entities are equal, wherein selecting the processing entity is further based upon a round robin selection of the at least some processing entities.

29. The method of claim 21, the method further comprising determining that the load level indications of at least some of the processing entities are equal, wherein selecting the processing entity is further based upon a random selection of the at least some processing entities.

30. The method of claim 21, wherein selecting the processing entity comprises selecting the processing entity that has a lowest load level based upon comparing the load level indications.

31. The method of claim 21, wherein the receiving and selecting are performed by a controller, and wherein the controller and processing entities are part of a node.

32. The method of claim 31, wherein the node comprises a mobile communications network node, and wherein the receiving and selecting are performed by the controller in the mobile communications network node.

33. The method of claim 21, wherein the receiving and selecting are performed by a first controller, the method further comprising:
a second controller receiving second load level indications associated with the processing entities, the second load level indications being representations based upon a non-linear function applied on loading of the processing entities; and
the second controller selecting from among the processing entities according to the second load level indications.

34. The method of claim 33, wherein the second load level indications received at the second controller are the same as the load level indications received by the controller, and wherein the receiving and selecting by the second controller are performed concurrently with the receiving and selecting by the first controller.

35. The method of claim 21, wherein receiving the load level indications associated with the processing entities comprises one of:
(1) receiving the load level indications from the processing entities; and
(2) receiving load information from the processing entities and computing the load level indications from the received load information.

36. A node for load balancing across processing entities, the node comprising:
a controller being configured to:
store load level indications based upon load information received from the processing entities, each load level indication being calculated by applying a non-linear function to a current loading of a corresponding processing entity; and
select a processing entity from among the processing entities to assign work to according to the load level indications.

37. The node of claim 36, wherein the non-linear function is a concave function.

38. The node of claim 36, wherein the non-linear function is a logarithmic formula.

39. The node of claim 36, wherein the controller in selecting the processing entity from among the processing entities also uses a window flow control procedure in which a number of service requests that can be submitted to any processing entity is limited to a maximum number.

40. The node of claim 36, wherein the controller is further configured to use hysteresis to increase or decrease load levels of the processing entities.
